(19) United States
(12) Patent Application Publication
(10) Pub. No.: US 2026/0114669 A1
(43) Pub. Date: Apr. 30, 2026

(54) VARIABLE TEMPERATURE SEARING AND COOKING GRILL

(71) Applicant: Brimstone Grill Inc., Peachtree Corners, GA (US)

(72) Inventors: Milton Leroy Hite, III, Duluth, GA (US); Adam Carter, Auburn, AL (US); Robert V. Terrell, Jr., Auburn, AL (US)

(21) Appl. No.: 19/372,950

(22) Filed: Oct. 29, 2025

Related U.S. Application Data
(60) Provisional application No. 63/833,155, filed on Oct. 29, 2024.

(51) Int. Cl. A47J 37/07; A47J 36/32; A47J 37/06; F04D 27/00; F24C 15/02; F24C 15/32

(52) U.S. Cl. CPC A47J 37/0754; A47J 36/32; A47J 37/0623; A47J 37/0704; F04D 27/004; F24C 15/022; F24C 15/322; A47J 2202/00

(57) ABSTRACT

An example device may include a fan that blows air in an enclosed channel, a heating chamber that causes burning connected to the enclosed channel which receives and heats the air, and a cooking chamber affixed to the burning chamber which receives the heated air, and the cooking chamber includes one or more temperature sensors in communication with an external controller configured to regulate a fan speed.

### FIELD OF INVENTION

Various embodiments relate to a grill and sear oven and a method for cooking and searing food at respective temperatures.

### BACKGROUND

Barbeque and similar cooking grills generally provide a limited temperature range for cooking. Professional chefs and restaurants often provide a superior meat cooking process since the equipment they use can offer larger temperature ranges necessary to slow cook and sear meat. Some options may include an infrared searing device that provides meat searing. Some of those more advanced cooking devices can cost over ten thousand dollars.

Many people still prefer using coals and/or wood to heat the grills for better flavor and temperature regulation. Those types of heat generation further complicate the process of offering high temperature searing options in a compact and affordable format.

Commercial kitchen grilling devices may use natural gas, propane, or electric as their fuel source and. Other products on the market are designed for low temperature and slow cooking using a fan controlled by a thermostat that reach grilling temperatures above 700 degrees. Temperatures need to exceed 1000 degrees in order to sear meet. Also, affordability and size are variables, which increase the market for such cooking grills. Searing meats is generally performed by flipping meats from one side to another. However, a steady flow of hot air can sear all sides of the meat without requiring intervention by the grill handler.

### SUMMARY

The appended claims may serve as a summary of one or more embodiments of a cooking and searing grill.

Further areas of applicability of the present disclosure will become apparent from the detailed description, the claims, and the drawings. The detailed description and specific examples are intended for illustration only and are not intended to limit the scope of the disclosure.

Example embodiments may include a device that can cook foods using charcoal and wood as fuel. The temperatures may be as low as 200 degrees and as high as 1750 degrees Fahrenheit. A digital interface may provide a computerized control option to increase fan speed and fuel consumption for increases and decreases in temperature.

When operating in a high temperature setting, the device may use a combination of heat flame, heated air and wind flow to sear and ‘caramelize’ the outside of meats.

An example device may include a fan that blows air in an enclosed channel, a heating chamber that causes burning connected to the enclosed channel which receives and heats the air, and a cooking chamber affixed to the burning chamber which receives the heated air, and the cooking chamber includes one or more temperature sensors in communication with an external controller configured to regulate a fan speed.

### BRIEF DESCRIPTION OF THE DRAWINGS

The present disclosure will become better understood from the detailed description and the drawings.

FIG. 1 illustrates an angled front view of a grill according to example embodiments.

FIG. 2 illustrates an angled top view of the grill according to example embodiments.

FIG. 3 illustrates an angled side view of the grill according to example embodiments.

FIG. 4 illustrates a bottom view of the grill according to example embodiments.

FIG. 5 illustrates an angled front view of the grill with the doors in an open position according to example embodiments.

FIG. 6 illustrates aside view cross-sectional of a side view of the grill demonstrating various internal components according to example embodiments.

FIG. 7 illustrates a method of operation of the grill according to example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method and apparatus as represented in the attached figures, is not intended to limit the scope of the application as claimed but is merely representative of selected embodiments. Multiple embodiments depicted herein are not intended to limit the scope of the solution.

The instant features, structures, or characteristics described in this specification may be combined in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one example. Thus, appearances of the phrases “example embodiments,” “in some embodiments,” “in other embodiments,” or other similar language, throughout this specification can all refer to the same embodiment. Thus, these embodiments may work in conjunction with any of the other embodiments, may not be functionally separate, and the described features, structures, or characteristics may be combined in any suitable manner in one or more embodiments.

Example embodiments provide a grill and sear oven that cooks food at a large range of temperatures. Temperatures may be implemented below 200 degrees, however, 225° F. for slow cooking and temperatures as high as 1750° F. for flash searing may be used. The grill may include a burn pot or heating chamber in the rear of the unit that is designed to be separate from the cooking area and which houses solid fuel (e.g., coal, wood, etc.). Multiple thermostats may be used on this unit to monitor temperatures in multiple zones of cooking. In one example, one thermostat may measure temperature at a lower level of the oven cooking area and another thermostat may measure temperature at a high lever near the top of the cooking area. A digital controller may monitor the temperatures from the different thermostats and programmatically control a fan to stoke the fire for a consistent temperature. The fan may be wired or wirelessly in communication with the controller and may receive control signals to increase a rate of speed (increase in temperature), decrease a rate of speed (decrease in temperature) or stop (rapid decrease in temperature).

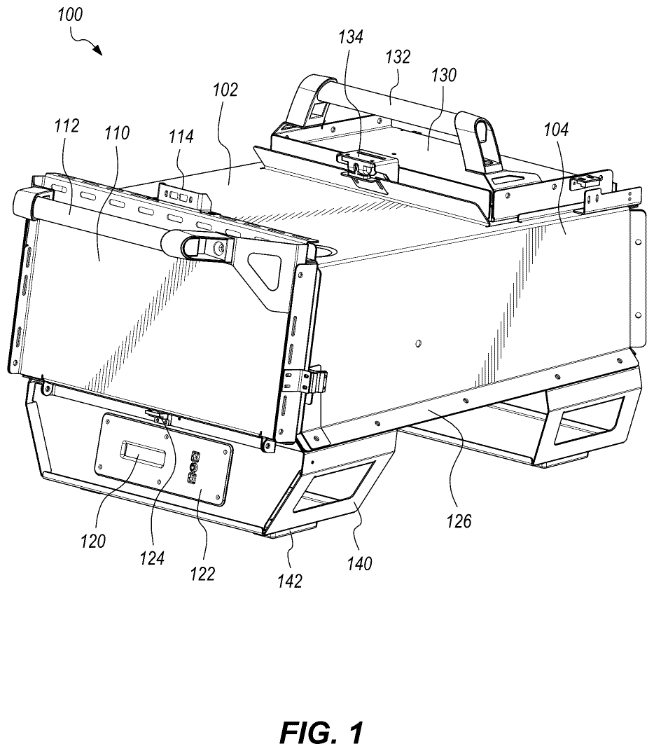

FIG. 1 illustrates an example illustration of an angled front view of a grill according to example embodiments. Referring to FIG. 1, the grill unit/device 100 may include a front door 110 with a door handle 112. The grill unit 100 may include a top portion 102 which along with the bottom, back, sides 104 and other portions, are outfitted with stainless steel and/or aluminum metal as a protective and aesthetically pleasing layer. The top of the front door may have a latch 114 and latch catching/capturing component that holds the door 100 in a fixed position until a user pulls down on the door handle 112 with a certain amount of force.

The lower portion of the front of the grill 100 may include a mounted plate with a controller interface or control panel 120 and a controller housing 122, which includes a digital interface and one or more menu selection buttons or keys. The interface may display target temperatures, settings, time durations, current temperatures and other information used by a user when cooking food inside the grill 100. A sensor 124 may be used to detect whether the door is open or closed. A reed shaped magnet may be used to secure the door in an open position.

The unit 100 sits on legs 140 as a sturdy cross-body configuration and the legs have feet 142, which provide an added layer of non-slip protection. A base layer 126 may be a portion of the frame that a holds the legs to the sides of the unit. In the back of the unit 100, another door is illustrated as a heating chamber door 130 (fire door) with a door handle 132. The inside of the heating chamber underneath the door 130 may be a multi-tiered surface where coal or firewood may rest and burn beneath a vent where air is forced into the heating chamber. The door 130 may also have its own latch 134.

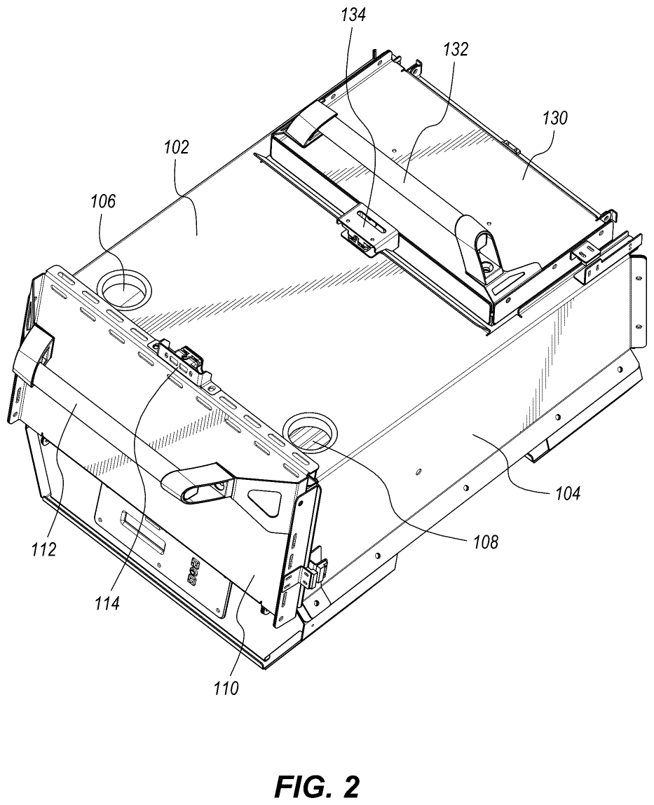

FIG. 2 illustrates an example illustration of an angled top view of the grill according to example embodiments. Referring to FIG. 2, the top of the grill 100 includes one or more air vents 106/108 which can permit the forced air flow to exit the unit. The vents are generally open all the time, however, additional embodiments may be contemplated where the vents are opened or closed manually or may open and close automatically depending on the amount of air pressure or a mechanical motor that is configured to control vent positions. A top panel 102 may represent a top surface of the unit. The heating chamber door 130 may have its own lock mechanism 134 used to avoid having the door accidentally fall open without a certain amount of pressure or force.

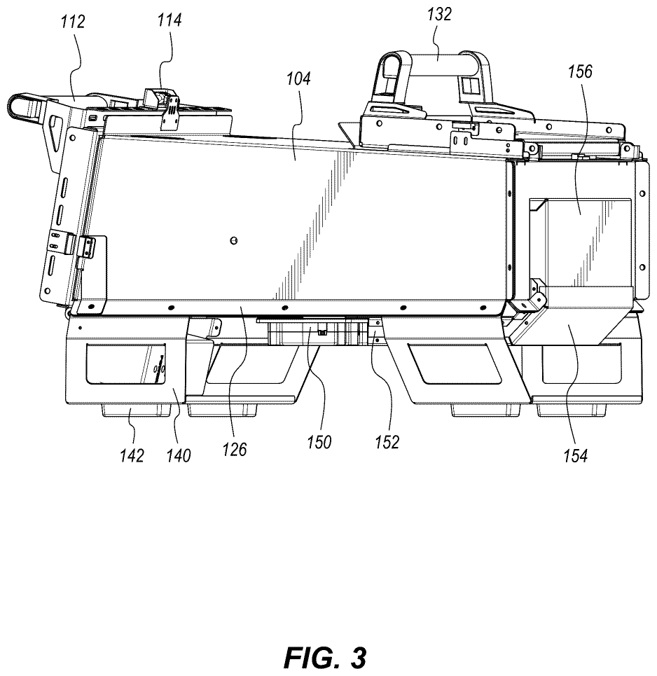

FIG. 3 illustrates an example illustration of an angled side view of the grill according to example embodiments. Referring to FIG. 3, the fan 150 is disposed on a bottom surface of the grill unit generally in a middle area. The fan 150 may be mounted by a mounting fan bracket affixed to an underside of the unit. An air flow channel 152 may be in direct contact with the fan 150 and the air may be forced along the channel to an upward facing vent channel 154, which is generally angled between 45 and 90 degrees upward towards the rear channel 156. The air intake interface may be a square or rectangular opening in the rear channel 156 that permits the forced fan air to flow into the heating or ‘burning’ chamber located at the rear of the unit. The side portion 104 represents an area that is predominantly occupied by the cooking chamber and with a lesser portion of the whole area 104 covering the burning chamber where the solid fuels may be burned. The air may flow into a top half portion of the burning chamber and the fan speed may determine a rate of air flow provided to the burning chamber.

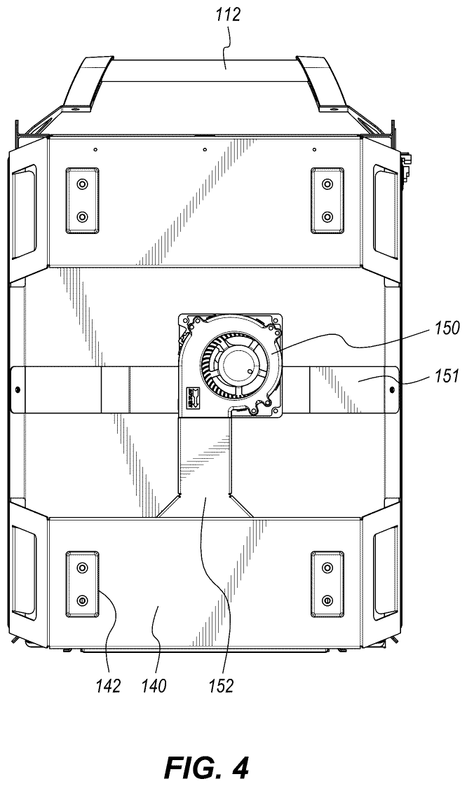

FIG. 4 illustrates an example illustration of a bottom view of the grill according to example embodiments. Referring to FIG. 4, the fan 150 may have a power controlled motor including an AC power supply source and/or a battery power source. The mounting brackets 151 may be on one or more sides of the fan to affix the fan to the bottom of the unit. A channel 152 illustrates the guided air flow that receives the forced air provided by the fan blades.

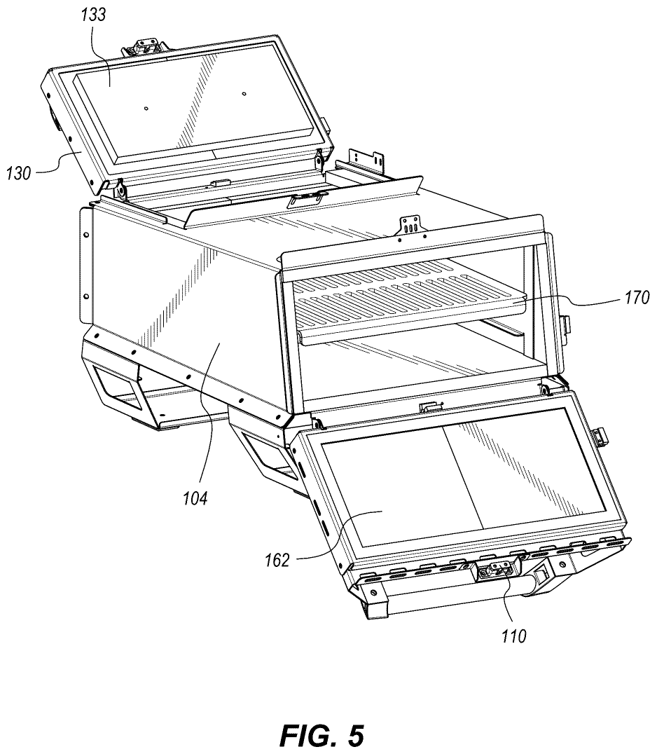

FIG. 5 illustrates an example illustration of an angled front view of the grill with the doors in an open position according to example embodiments. Referring to FIG. 5, the unit is illustrated as being in an open position with the front door or cooking chamber door 110 and the burning chamber door 130 both in open positions. A surface area of the door may be reinforced with stone or other similar type material 162, which provides thermal temperature preserving properties. Also, the backside of the burning chamber door 133 may also be reinforced with stone or similar material. The insides of the cooking chamber and/or the burning chamber may also include stone or similar material reinforcement to prevent heat escape and avoid warping of the metal structure. The inside of the grill may have a shelf that accommodates a grill grate 170 or other resting surface for food to be laid during a cooking cycle.

The heat and flame created in the heating fire box chamber (heating chamber) inside and under the heating chamber door 130 will be pushed from the back of the unit to the front of the cooking chamber along the ceiling. The fan 150 creates a convective flow in the unit which permits low temperature cooking or high temperature cooking. The increasing flow rate fuels the fire to reach temperatures around 1750° F. The air intake, air exhaust, and air fan 150 are sized appropriately to provide a desired wind speed range across the fuel in the heating chamber to provide optimal conditions for fuel burn. The intake port has been positioned in a configuration intended to provide a laminar flow across the fuel for an even temperature distribution for cooking the food, while the exhaust is designed to turbulate the exhaust gas prior to exiting the chamber, thereby creating a convective current within the cooking chamber. Various portions of the grill are lined with stone (or similar material) panels generally throughout the entire unit, including the cooking chamber door and the heating chamber lid, to help the thinner external metal surfaces from degrading and warping, along with retaining heat inside for better fuel consumption.

The controller unit 122 may be a proportional integral derivative (PID) controller that uses a temperature calibration table methodology, which enables relocation of the temperature sensor(s) to be out of the way of the more extreme heat zones inside the cooker. Temperature tables, which may be stored in a memory of the controller 122, may be used in thermostatically controlled products as they permit a sensor to be calibrated programmatically, such as by obtaining temperature readings from a side wall position inside the cooker. In one example, assuming that a temperature reading of one first sensor is currently 700° F., it can be assumed based on previous temperature data collection that, for example, two inches closer to the center will be 900° F. and four inches from the sensor may be 1750° F. as a type of estimation process. This type of temperature estimation is achieved without moving the sensor(s), which protects the sensor(s) from extreme temperatures since it is not common to have a temperature recording device that can withstand 1750° F.

An ignite feature may be used by the controller to provide a small breeze from the fan to help ignite the fire without extinguishing it prematurely. The controller 122 may control a speed of the fan via a wired signal or a wireless signal. The control may be set up to increase a fan speed when a desired temperature level is sought to be higher than a current temperature measured.

In one example, multiple sensors 124 and near latch 134 (temperature, motion, etc.) are placed near the doors, may be used to control the controller to turn the fan 150 off while the doors are open and reengage them when the doors are closed. The sensor signal may be sent to the controller 122 and is a programmatic function. The walls, floor, door, ceiling and other portions of the inside of the cooking device may be lined with stone or other similar material. For example, the stone may be primarily a ceramic stone, or as an alternative, it may be Cordierite stone, among other options. The areas on the outside of the stone are lined with a metal shell surrounding the stone. An additional exterior heat shield may be used to protect the user from burns while also providing an aesthetic appearance. The unit has a digital controller 122 and display interface to provide input and output data for unit operation, such as temperatures and other control information.

The controller 122 may use PID logic to power the fan 150 at varying speeds to regulate a temperature range of 225° F.-1750° F. and alternatively shorter ranges in between. In one example, a fuel source may be wood. Alternate fuel sources include natural gas, propane, and other solid fuels, such as charcoal, pellets, and briquettes. A target temperature range may be 225° F.-1750°, however other temperature ranges are contemplated. In one example, an alternate temperature range for the cooking chamber is 160° F.-2000° F. The cooking chamber material on the internal portion of the grill may be a generic ceramic stone or fire brick material. Example options for materials may include ceramic, Cordierite, Mullite, Alumina, Silicon Carbide, and Soap Stone.

Examples of alternate internal insulation of the unit may include dual wall construction with an air gap between walls, fibrous refractory compounds to include silica and wool blends (e.g., biofiber blanket). Non-fibrous insulation options may include (e.g. Vermiculite/Perlite board). The cooking chamber enclosure may be lined with metal or other material to encase the cooking chamber. Alternate materials may include cold rolled steel, aluminum, and ceramic composite. Alternate cooking chamber construction may include a standalone construction avoiding the use of additional walls to surround the chamber.

One example may include a positive pressure system, which requires forced air to be introduced into the cooking chamber. A neutral air system will prevent additional burning that typically results in higher ‘run-away’ temperatures. Such a configuration permits certain proportional integral derivative (PID) tolerances and the ability to cook at low temperatures, while allowing the unit to react fast to reach higher temperatures when necessary.

Cooking in a positive pressure environment may increase the cooking rate due to multiple factors. Pressure is one factor to consider when cooking, and with the active fan speed and related controls, the pressure will provide a more uniform burn and aggressive airflow rate.

The controller 122 may utilize data from both temperature sensors 206 and 208 to estimate the temperature inside the unit. The difference in temperature from multiple temperature sensors may be known as accurate or inaccurate based on the difference value and prior testing scenarios and estimation techniques. A target temperature difference range may be required for the controller to identify an accurate estimated temperature.

The control portion of the grill is designed with digital controls to regulate temperatures via an electro-mechanical fan 150 via applied PID logic utilized by the control system. In one example, a radial/blower fan may be used, and in other examples, an axial fan and tangential fans (i.e., crossflow) have been tested and used as alternatives. Other alternative fans may include an inline duct, regenerative, and mixed-flow fan. A direct mounted fan may be used; however, a Venturi style fan system may also be used. In general, a propane and natural gas fuel alternative will not require a fan or digital controls. If using an electric power source, the unit may be powered by AC or DC voltage, which includes, but is not limited to: wall power supplies, on-board power supplies, and battery packs (rechargeable and non-rechargeable). The grill will be able to monitor both the front door used to place and remove food inside the cooking chamber and the rear door used to add firewood and other solid fuels to accurately troubleshoot and provide programmatic functions that will control the operation of the unit.

In one example, type ‘K’ thermocouple sensors may be used in two separate locations. In some cases one sensor would be used, however, having two separate temperature sensors in strategic locations can help identify accurate temperatures in more than one location and this provides a more accurate desired temperature for the cooking chamber. One temperature sensor probe will be disposed higher inside the cooking chamber with respect to the ground and the other will be disposed lower. The two-sensor configuration provides the controller 122 with the ability to read two temperature zones and adjust the fan based on a desired temperature. When ‘smoking’ food at a lower temperature, the lower rack temperature position is critical, and when ‘searing’ food, the top rack temperature position is more important. Also, a difference in temperature (ΔT) between the two thermocouple sensors may be detected and measured to provide an estimate as to the temperature at any given position within the cooking chamber.

Generally, the air intake is provided by the fan 150 that draws external air into the grill and blows the air through the fan opening into an expansion duct 152 that can be throttled by the intake opening size. An air inlet location may be centered on the back wall of the unit. Various shapes and sizes are possible to include as options for a single intake vent or a plurality of intake vents that permit air to be drawn from outside the unit to inside the unit at the location of fuel burning. The air entering the intake is directed over the firebox/heating chamber area and is aligned to blow into a top half of the fuel source burning/combustion area. Blowing the air lower in the chamber may cause ash to blow throughout the unit.

The cooking chamber provides the air to flow from the heating chamber of the rear of the unit across the top surface of the unit to the exhaust ports 106 and 108. The exhaust ports/holes are placed on the top surface close to the perimeter walls. As the air flows from the back of the unit toward the front the path of the unit, a least amount of resistance is in the center of the unit. By placing the vents outboard, the heat can be disbursed across the top rack, which balances and minimize the ΔT (temperature difference) in the cooking area. When vents are placed relatively too close to the center, a hot zone is created in the center of the cooking rack and colder areas form on the perimeter areas, which is not ideal for cooking and food placement. Additionally, as the heat travels forward, it collides with the front door and creates a convection thereby sending heat to the lower portion of the cabinet and other areas. Alternate arrangements may include various shapes and sizes, which are possible to include as options for a single intake or a plurality of intakes.

In one example, air duct intake and exhaust sizing should be equal in total surface area (1:1 ratio). The equal intake and exhaust configuration is then paired with a fan to provide the proper wind speed to throttle the burning of the solid fuel. In one example, the ideal exit speed from the intake will be between 9-10 miles per hour at a maximum fan speed. In one example, the fan that was selected for the unit may have an output of 36.2 cubic feet per minute (cfm).

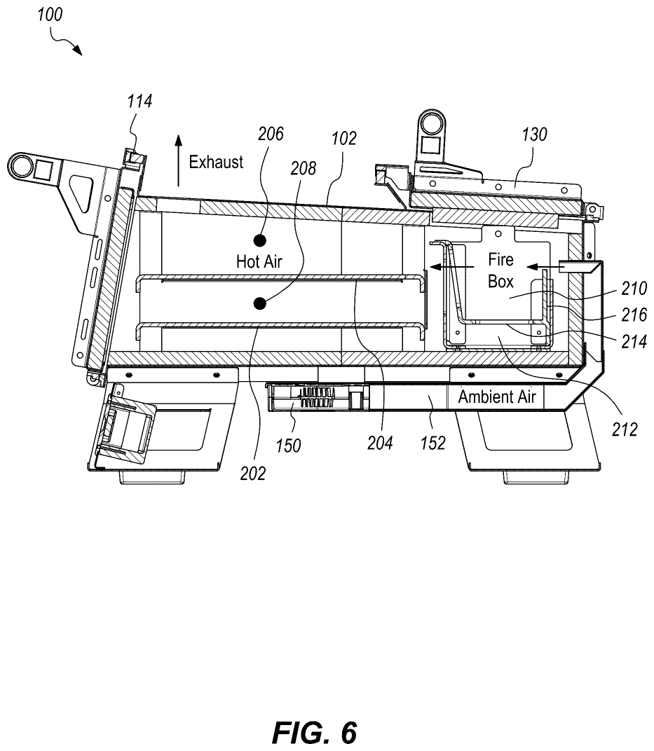

FIG. 6 illustrates an example side view cross-sectional of a side view of the grill demonstrating various internal components according to example embodiments. Referring to FIG. 6, the grill 100 is illustrated with internal components including a lower cooking surface 202, a middle or upper cooking surface 204. In general, the forced air being provided by the fan 150 is channeled through the fixed air channel 152 into the heating chamber 210. The fuel may be placed in the heating chamber 210 which may include a main ash grate 214, which may be L-shaped and an additional ash grate 216 which may be a vertical grate that rests against the L-shaped grate 214. The ashes may fall through the grate into an ash cup or tray 212, which can be emptied periodically. A main frame of metal may rest on the ash tray 212 and provide a housing structure for the ash grates 214/216. All the components can be easily removed for cleaning after a burning session. The lid opens and closes to provide easy access to providing additional fuel.

A plurality of sensors/probes 206/208 may be used to measure temperatures in the cooking chamber. The upper sensor 206 may be disposed on a wall surface at a higher position inside the cooking chamber and the lower sensor 208 may be disposed on a wall surface at a lower position in the cooking chamber. The readings for temperature provided by the sensors 206/208 are generally not the same. The higher sensor will be generally higher and in some cases, such as when performing a searing operation, will be much higher, such as hundreds of degrees Fahrenheit higher than the lower sensor. Averages, comparisons and deviations between the sensor readings may be used to estimate an average temperature in the cooking chamber, on the top rack and/or on the bottom rack based on known estimation techniques. The sensors 206/208 may provide temperature information to the controller 120 so the fan speed can be adjusted accordingly depending on the mode of operation. In one example, the mode may be a low temperature cooking cycle, a high temperature cooking cycle, a mixed temperature cooking cycle (hot then less hot or less hot the hot) and a searing cooking temperature (extremely hot, over one thousand degrees Fahrenheit).

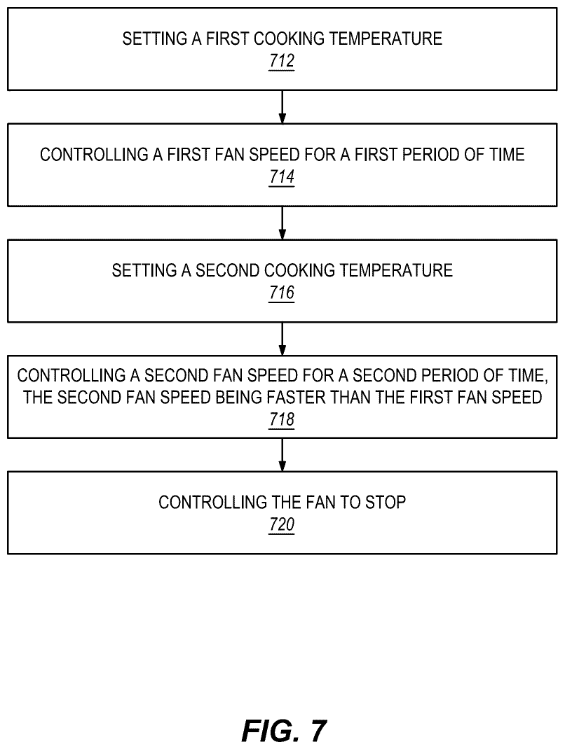

FIG. 7 illustrates an example method of operation of the grill according to example embodiments. Referring to FIG. 7, a first cooking temperature may be set 712 by the user interface for a cooking cycle. As the cooking begins and the fuel is burned, an initial fan speed may be set in an attempt to control the temperature for a period of time 714. The speed of the fan will be generally increased until a target temperature is reached. The period of time may be a predetermine value or may be identified based on the feedback from the one or more temperature sensors. The temperature may be maintained as a single cooking temperature to remain throughout the cooking cycle. In another example, the temperature may be changed to add a second searing temperature 716 cycle to the process, or alternatively, the searing may have been performed first and a lesser cooking temperature may be imposed as the second temperature. As a result, fan speed may be modified for a second period of time 718. The fan speed may be faster or slower to match the temperature target. The amount of time may be variable. However, in this example, the fan speed is faster the second time than the fan speed the first time. Generally, a faster fan speed is going to result in a higher cooking temperature. Once all the cooking is completed, the fan will be instructed to stop 720. The controls may be sent via wireline signals or wireless signal sent from the controller to the fan.

Example embodiments include a grilling device that includes a fan that blows air in an enclosed channel, a heating chamber that causes burning connected to the enclosed channel which receives and heats the air, and a cooking chamber affixed to the burning chamber which receives the heated air, and the cooking chamber may include one or more temperature sensors in communication with an external controller configured to regulate a fan speed.

The cooking chamber door is lined with stone that locks via a latch. A heating chamber door is also with stone and locks via a latch. The cooking chamber door triggers another sensor in an open position which causes the fan to stop blowing. The heating chamber door triggers another sensor in an open position which causes the fan to stop blowing. The controller measures a difference in temperature between two of the one or more temperature sensors and estimates a temperature of the cooking chamber based on the difference, and wherein when the estimated temperature is below a set temperature, the controller sends a signal to the fan to increase the fan speed. The enclosed channel is affixed to one side of the heating chamber. The controller includes memory and a digital user interface with a display and user interface for receiving input selections by a user.

One example method of operation may include setting, via a controller, a first cooking temperature, controlling, via the controller, a first fan speed to blow air into a cooking chamber of a grill for a first period of time, modifying, via the controller, the fan speed to a new fan speed, controlling, via the controller, the fan to operate at the new fan speed for another period of time, and controlling, via the controller, the fan to stop. The method may also include identifying, via the controller, the temperature is below the first cooking temperature, and modifying, via the controller, the fan speed to increase to a faster fan speed. The method may also include identifying, via the controller, the temperature is above the first cooking temperature, and modifying, via the controller, the fan speed to decrease to a slower fan speed. After the first period of time, identifying via the controller, two sensor measurements received from two separate sensors disposed in the cooking chamber are respectively above and below the cooking temperature. The method may also include performing, via the controller, a proportional integral derivative computation to determine whether the fan speed should be increased or decreased. The method may also include setting a second temperature and a corresponding second fan speed for a second period of time, wherein the second fan speed is faster than the first fan speed and the new fan speed.

Another example device may include a grill device that includes a cooking chamber, a controller configured to set a first cooking temperature, and a fan controlled by the controller to cause the fan to flow air at a first fan speed into the cooking chamber of the grill for a first period of time, and the controller is further configured to modify the fan speed to a new fan speed, control the fan to operate at the new fan speed for another period of time, and control the fan to stop. The controller is further configured to identify the temperature is below the first cooking temperature, and modify the fan speed to increase to a faster fan speed, or identify the temperature is above the first cooking temperature, and modify the fan speed to decrease to a slower fan speed. After the first period of time, the controller is configured to identify, via the controller, two sensor measurements received from two separate sensors disposed in the cooking chamber, are respectively above and below the cooking temperature. The controller is further configured to perform a proportional integral derivative computation to determine whether the fan speed should be increased or decreased. The controller is further configured to set a second temperature and a corresponding second fan speed for a second period of time, and the second fan speed is faster than the first fan speed and the new fan speed. A lid of the cooking chamber may be lined with ceramic.

It will be readily understood the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these embodiments, it would be apparent to those of skill in the art that certain modifications, variations, and alternative constructions would be apparent.

While preferred embodiments of the present application have been described, it is to be understood the embodiments described are illustrative only and the scope of the application is to be defined solely by the appended claims when considered with a full range of equivalents and modifications thereto.

In this specification, reference is made in detail to specific embodiments of the invention. Some of the embodiments or their aspects are illustrated in the drawings.

For clarity in explanation, the disclosure has been described with reference to specific embodiments, however, it should be understood the disclosure is not limited to the described embodiments. On the contrary, the disclosure covers alternatives, modifications, and equivalents as may be included within its scope as defined by any patent claims. The following embodiments are set forth without any loss of generality to, and without imposing limitations on, the claimed invention. In the following description, specific details are set forth in order to provide a thorough understanding of the present disclosure. The present disclosure may be practiced without some or all of these specific details. In addition, well-known features may not have been described in detail to avoid unnecessarily obscuring the disclosure.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A grilling device comprising:
a fan that blows air in an enclosed channel;
a heating chamber that causes burning connected to the enclosed channel which receives and heats the air; and
a cooking chamber affixed to the burning chamber which receives the heated air, wherein the cooking chamber comprises one or more temperature sensors in communication with an external controller configured to regulate a fan speed.

2. The grilling device of claim 1, comprising:
a cooking chamber door lined with stone that locks via a latch.

3. The grilling device of claim 1, comprising:
a heating chamber door lined with stone that locks via a latch.

4. The grilling device of claim 1, wherein the cooking chamber door triggers another sensor in an open position which causes the fan to stop blowing.

5. The grilling device of claim 1, wherein the heating chamber door triggers another sensor in an open position which causes the fan to stop blowing.

6. The grilling device of claim 1, wherein the controller measures a difference in temperature between two of the one or more temperature sensors and estimates a temperature of the cooking chamber based on the difference, and wherein when the estimated temperature is below a set temperature, the controller sends a signal to the fan to increase the fan speed.

7. The grilling device of claim 1, wherein the enclosed channel is affixed to one side of the heating chamber.

8. The grilling device of claim 1, wherein the controller comprises memory and a digital user interface with a display and user interface for receiving input selections by a user.

9. A method comprising:
setting, via a controller, a first cooking temperature;
controlling, via the controller, a first fan speed to blow air into a cooking chamber of a grill for a first period of time;
modifying, via the controller, the fan speed to a new fan speed;
controlling, via the controller, the fan to operate at the new fan speed for another period of time; and
controlling, via the controller, the fan to stop.

10. The method of claim 9, comprising:
identifying, via the controller, the temperature is below the first cooking temperature; and
modifying, via the controller, the fan speed to increase to a faster fan speed.

11. The method of claim 9, comprising:
identifying, via the controller, the temperature is above the first cooking temperature; and
modifying, via the controller, the fan speed to decrease to a slower fan speed.

12. The method of claim 9, wherein after the first period of time, identifying via the controller, two sensor measurements received from two separate sensors disposed in the cooking chamber are respectively above and below the cooking temperature.

13. The method of claim 11, comprising:
performing, via the controller, a proportional integral derivative computation to determine whether the fan speed should be increased or decreased.

14. The method of claim 8, comprising:
setting a second temperature and a corresponding second fan speed for a second period of time, wherein the second fan speed is faster than the first fan speed and the new fan speed.

15. A grill device comprising:
a cooking chamber;
a controller configured to set a first cooking temperature; and
a fan controlled by the controller to cause the fan to flow air at a first fan speed into the cooking chamber of the grill for a first period of time;
and wherein the controller is further configured to
modify the fan speed to a new fan speed;
control the fan to operate at the new fan speed for another period of time; and
control the fan to stop.

16. The grill device of claim 15, wherein the controller is further configured to
identify the temperature is below the first cooking temperature; and
modify the fan speed to increase to a faster fan speed.

17. The grill device of claim 15, wherein the controller is further configured to:
identify the temperature is above the first cooking temperature; and
modify the fan speed to decrease to a slower fan speed.

18. The grill device of claim 15, wherein after the first period of time, the controller is configured to identify two sensor measurements received from two separate sensors disposed in the cooking chamber, are respectively above and below the cooking temperature.

19. The grill device of claim 17, wherein the controller is further configured to perform a proportional integral derivative computation to determine whether the fan speed should be increased or decreased.

20. The grill device of claim 18, wherein the controller is further configured to set a second temperature and a corresponding second fan speed for a second period of time, wherein the second fan speed is faster than the first fan speed and the new fan speed.
